(19) United States
(12) Patent Application Publication
(10) Pub. No.: US 2022/0350152 A1
(43) Pub. Date: Nov. 3, 2022

(54) WEARABLE HEADS-UP DISPLAYS

(71) Applicant: GOOGLE LLC, Mountain View, CA (US)

(72) Inventor: Daniel Adema, Kitchener (CA)

(21) Appl. No.: 17/774,005

(22) PCT Filed: Feb. 3, 2021
(86) PCT No.: PCT/US2021/016359

§ 371 Date: May 3, 2022

Related U.S. Application Data
(60) Provisional application No. 62/969,217, filed on Feb. 3, 2020.

(51) Int. Cl. G02B 27/01; G02C 5/14; G02C 11/00

(52) U.S. Cl. CPC G02B 27/0172; G02C 5/14; G02C 11/10; G02B 2027/0178

(57) ABSTRACT

There is provided a wearable heads-up display (WHUD) having a glasses frame, which may comprise a front frame and first and second temple arms each coupled to the front frame. At least a portion of the first temple arm may be foldable relative to the front frame at a first interface disposed at a first distance along the first temple arm away from the front frame. Similarly, at least a portion of the second temple arm may be foldable relative to the front frame at a second interface disposed at a second distance along the second temple arm away from the front frame. The first distance may be different than the second distance. The WHUD may also include a light engine and a display optic both mounted to the glasses frame, and used to form an image viewable by a user of the WHUD.

### BACKGROUND

Displays may be used to form still or moving images. Some displays may use a display panel to form images. Examples of such display panels include Light Emitting Diode (LED) display panels, Liquid Crystal Display (LCD) panels, and the like. In addition, some displays may use projectors to project still or moving images. Small displays may be used to form, or as a part of, mobile or wearable devices. For example, some displays may form or be part of a wearable heads-up display.

### SUMMARY OF EMBODIMENTS

According to an implementation of the present specification there is provided a wearable heads-up display (WHUD) comprising: a glasses frame comprising a front frame and a first temple arm and a second temple arm that are each coupled to the front frame, at least a portion of the first temple arm foldable relative to the front frame at a first interface disposed at a first distance from the front frame along an inner side of the first temple arm, and at least a portion of the second temple arm foldable relative to the front frame at a second interface disposed at a second distance from the front frame along an inner side of the second temple arm, the first distance different than the second distance and the inner side of the first temple arm facing the inner side of the second temple arm; a light engine mounted to the glasses frame, the light engine to generate a display light; and a display optic mounted to the glasses frame, the display optic to receive the display light from the light engine and direct the display light towards an eye of a user of the WHUD to form an image viewable by the user.

The first distance may be longer than the second distance.

The light engine may be mounted to the first temple arm.

The first temple arm may comprise a first portion disposed between the first interface and the front frame and a second portion disposed between the first interface and a distal end of the first temple arm that is remote from the front frame. The light engine may be mounted to the first portion of the first temple arm.

The first interface may be positioned outside of an optical path of the display light from the light engine to the display optic.

The first portion may be immovably coupled to the front frame.

The first interface may extend from a first interface position located at the first distance from the front frame along the inner side of the first temple arm to a first perceived interface position at a third distance from the front frame along an outer side of the first temple arm. The second interface may extend from a second interface position located at the second distance from the front frame along the inner side of the second temple arm to a second perceived interface position at the third distance from the front frame along an outer side of the second temple arm. The outer side of the first temple arm may be opposite the inner side of the first temple arm and the outer side of the second temple arm may be opposite the inner side of the second temple arm.

The third distance may be distinct from the first distance and from the second distance.

At least one interface of the first interface and second interface may be curvilinear.

The second distance may be about zero.

One or more of the first temple arm and the second temple arm may be hinged at the first interface and the second interface respectively; and one or more of the corresponding first interface and second interface may comprise respectively a first hinge position along the first temple arm and a second hinge position along the second temple arm.

The light engine may comprise a light source to emit the display light.

The light source may comprise a laser to emit the display light.

The light engine may further comprise a spatial modulator to receive the display light from the light source and direct the display light onto the display optic.

The spatial modulator may comprise a movable reflector.

The display optic may comprise a diffractive optical element.

The WHUD may further comprise a lens mounted to the front frame; and the display optic may be mounted to the lens.

The WHUD may further comprise a battery to power the light engine.

The first distance may be longer than the second distance; and the battery may be mounted to the second temple arm.

The WHUD may further comprise a controller in communication with the light engine, the controller to control the light engine.

The light engine may comprise a light source and a spatial modulator, and the controller may be to control one or more of the light source and the spatial modulator.

The first distance may be longer than the second distance; and the glasses frame may have a folded configuration wherein: the portion of the second temple arm folds against the front frame to form a folded second temple arm; and the corresponding portion of the first temple arm folds against the folded second temple arm.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 shows a schematic representation of an example system which may be used to form or project an image, in accordance with a non-limiting implementation of the present specification.

FIG. 2 shows a partial-cutaway perspective view of an example wearable heads-up display, in accordance with a non-limiting implementation of the present specification.

FIG. 3 shows a partial top perspective view of another example wearable heads-up display, in accordance with a non-limiting implementation of the present specification.

FIG. 4 shows a top plan view of the wearable heads-up display shown in FIG. 3.

FIG. 5 shows a top plan view of the wearable heads-up display shown in FIG. 3 in a folded configuration.

FIG. 6 shows a partial-cutaway perspective view of yet another example wearable heads-up display, in accordance with a non-limiting implementation of the present specification.

FIG. 7 shows a partial top perspective view of yet another example wearable heads-up display, in accordance with a non-limiting implementation of the present specification.

FIG. 8 shows a top plan view of the wearable heads-up display shown in FIG. 7.

FIG. 9 shows a top plan view of the wearable heads-up display shown in FIG. 7 in a folded configuration.

FIG. 10 shows simplified top and side plan views of an example configuration of temple arms for a wearable heads-up display, in accordance with a non-limiting implementation of the present specification.

FIG. 11 shows simplified top and side plan views of an alternative example configuration of temple arms for a wearable heads-up display, in accordance with a non-limiting implementation of the present specification.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, and the like. In other instances, well-known structures associated with light sources have not been shown or described in detail to avoid unnecessarily obscuring descriptions of the implementations.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

Throughout this specification and the appended claims, the term “carries” or “mounted,” and variants such as “carried by,” “mounted to,” or “mounted on,” are generally used to refer to a physical coupling between two objects. The physical coupling may be direct physical coupling (i.e. with direct physical contact between the two objects) or indirect physical coupling that may be mediated by one or more additional objects. Thus, the term carries and variants such as “carried by” are meant to generally encompass all manner of direct and indirect physical coupling, including without limitation: carried on, carried within, physically coupled to, secured to, mounted to, mounted on, or supported by, with or without any number of intermediary physical objects therebetween.

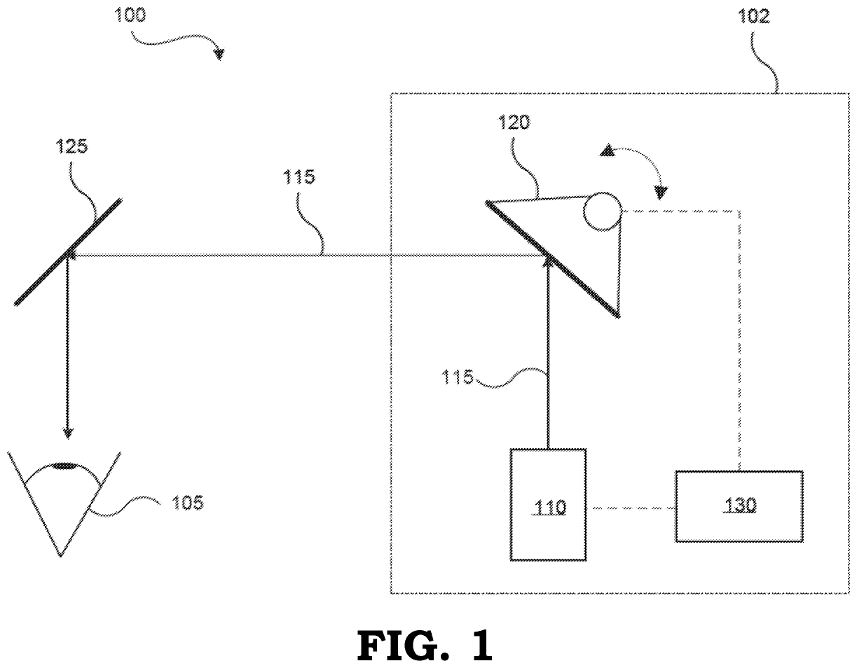

FIG. 1 shows a schematic representation of an example system 100, which system 100 may be used to form or project an image viewable by an eye 105 of a viewer. System 100 may also be referred to or described as an image projection device, a display device, a display system, or a display. The viewer may also be described as a user of system 100. System 100 may comprise a light engine 102 to generate a beam of display light 115. In some examples, light engine 102 may comprise a light source 110 to generate display light 115. Light source 110 may comprise at least one laser, at least one light emitting diode, and the like. Light engine 102 may also comprise a spatial modulator 120 to receive display light 115 from light source 110. In some examples, spatial modulator 120 may comprise a movable reflector. In some examples, such movable reflectors may be fabricated as or incorporated in a micro-electro-mechanical system (MEMS), a digital micromirror device (DMD), and the like. In some examples, spatial modulator 120 may be part of a relay optic of system 100.

While FIG. 1 shows light engine 102 as comprising spatial modulator 120, it is contemplated that in some examples light engine 102 need not comprise spatial modulator 120 or light source 110. In some examples, light engine 102 may comprise a micro-display, or other light sources suitable for forming an image.

Furthermore, system 100 may comprise a display optic 125 to receive display light 115 from light engine 102 and direct the display light towards eye 105 of a user of the system 100 to form an image viewable by the user. In some examples, display optic 125 may comprise a light guide and/or a wave guide. Moreover, in some examples, display optic 125 may also comprise an incoupler and an outcoupler optically coupled to the light guide and/or wave guide.

In addition, in some examples, one or more of the incoupler and the outcoupler may comprise a diffractive optical element such as a surface relief grating, a hologram, and the like. The incoupler may receive display light 115 from light engine 102 and direct at least a portion of the display light into the light guide to form an incoupled light propagating in the light guide. Once the incoupled light becomes incident upon the outcoupler, the outcoupler may direct at least a portion of the incoupled light out of the light guide to form an outcoupled light propagating towards eye 105 of the user of system 100.

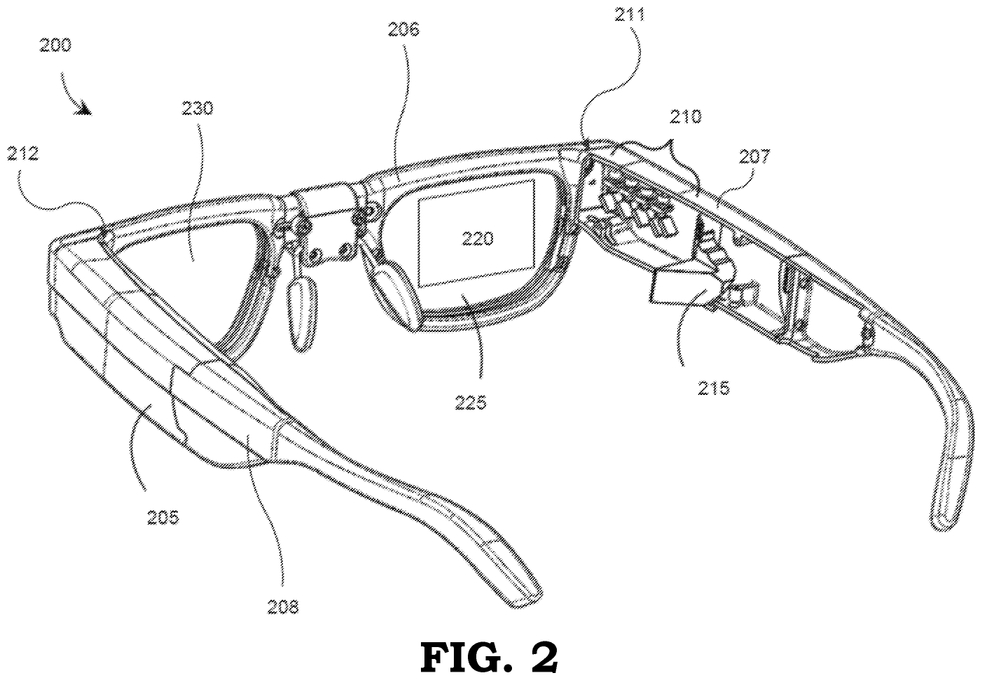

Moreover, in some examples system 100 may be a part of or incorporated into a wearable heads-up display (WHUD). Such a heads-up display may have different designs or form factors, such as the form factor of eyeglasses, as is described in greater detail in relation to FIGS. 2-9. In some of the examples where system 100 is in the form factor of glasses, display optic 125 may be on or in a lens of the glasses.

In addition, in some examples light engine 102 may comprise a controller 130 in communication with light source 110 and spatial modulator 120. Controller 130 may control light source 110 and spatial modulator 120 to project an image. In some examples, the image to be projected may be a still image, a moving image or video, an interactive image, a graphical user interface, and the like. It is also contemplated that in some examples, controller 130 need not be a part of light engine 102. In such examples, controller 130 may be a component of system 100 external to or distinct from light engine 102.

In some examples, the controllers described herein such as controller 130 may comprise a processor in communication with a non-transitory processor-readable medium. The processor-readable medium may comprise instructions to cause the processors to control the light source and the spatial modulator to form images viewable by the user of system 100. Moreover, in some examples the controllers may be free-standing components, while in other examples the controllers may comprise functional modules incorporated into other components of their respective systems.

Furthermore, in some examples the controllers or their functionality may be implemented in other ways, including: via Application Specific Integrated Circuits (ASICs), in standard integrated circuits, as one or more computer programs executed by one or more computers (e.g., as one or more programs running on one or more computer systems), as one or more programs executed by one or more controllers (e.g., microcontrollers), as one or more programs executed by one or more processors (e.g., microprocessors, central processing units, graphical processing units), as firmware, and the like, or as a combination thereof.

Turning now to FIG. 2, a partial-cutaway perspective view of an example wearable heads-up display (WHUD) 200 is shown. WHUD 200 includes a support structure 205 that in use is worn on the head of a user and has the general form factor and appearance of an eyeglasses (e.g. sunglasses) frame. Eyeglasses or sunglasses may also be generically referred to as “glasses”. As shown in FIG. 2, support structure 205 may comprise a glasses frame comprising a front frame 206, and a first temple arm 207 and a second temple arm 208 each coupled to front frame 206.

In some examples, the front frame may comprise a portion of the glasses frame that is worn in front of the face of a user of the glasses. Moreover, in some examples, the front frame may also comprise a bridge, or bridge portion, to extend over a nose of the user. Furthermore, in some examples, the front frame may receive or otherwise support one or more lenses to be disposed in a line of sight of the user when the glasses are worn by the user.

In addition, in some examples, temple arms are worn proximate a side of the head of the user when the glasses are worn by the user. In relation to how or where temple arms are worn, “proximate the side of the head of the user” may also be described as “proximate a side of the face of the user”. Furthermore, in some examples, a temple arm may extend past or behind a corresponding ear of the user. The temple arms may connect to the front frame to support the front frame in front of the face of the user when the glasses are worn by the user.

Turning back to FIG. 2, the glasses frame is shown in an extended or unfolded configuration to allow WHUD 200 to be worn by a user. To allow for more compact storage, at least a portion of each of temple arms 207 and 208 may be foldable relative to front frame 206. As shown in FIG. 2, temple arm 207 may be foldable relative to front frame 206 at an interface 211. This interface may be where an end of temple arm 207 attaches to front frame 206. Moreover, temple arm 208 may be foldable relative to front frame 206 at an interface 212. Similar to interface 211, interface 212 may also be positioned where an end of temple arm 208 attaches to front frame 206.

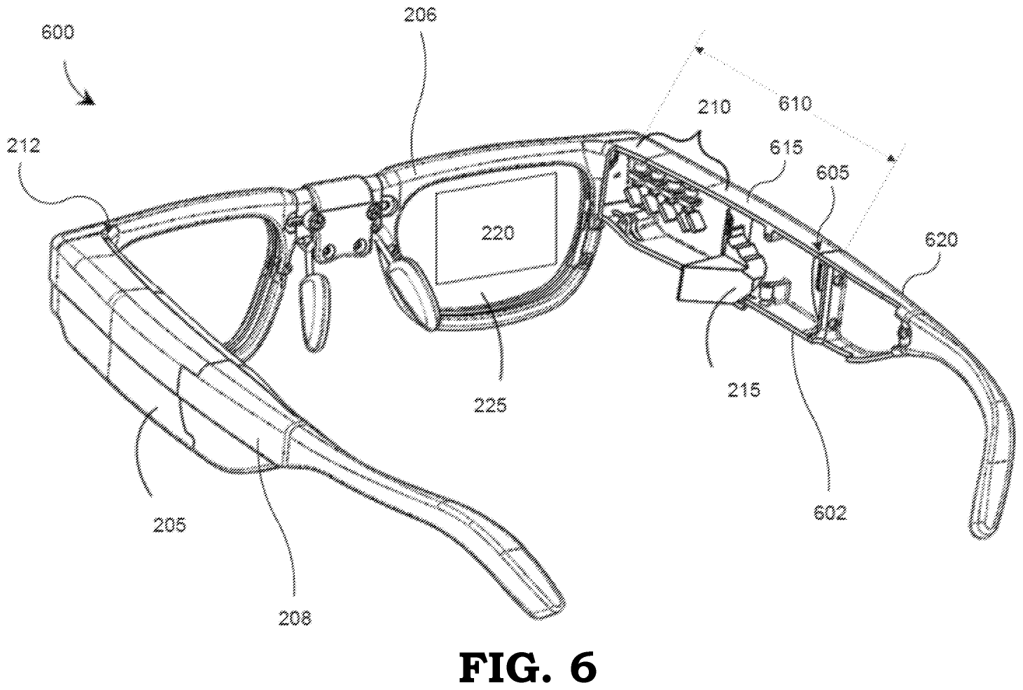

While in FIG. 2 interfaces 211 and 212 are disposed at respective ends of temple arms 207 and 208, it is contemplated that in some examples the interfaces may be disposed at a different position along the length of each temple arm. In other words, while in FIG. 2 there is an about zero distance between each of interfaces 211,212 and front frame 206, it is contemplated that in some examples one or more of interfaces 211 and 212 may be disposed at greater, non-zero distances away from front frame 206 along temple arms 207 and 208 respectively. Examples of such interfaces that are disposed further away from the front frame along their respective temple arms are described in greater detail in relation to FIGS. 6-9.

Moreover, in some examples, one or more of temple arms 207 and 208 may be hinged to front frame 206 at interfaces 211 and 212 respectively. Such hinges may allow the temple arms to fold relative to front frame 206. Furthermore, support structure 205 may carry components of a system to display an image, such as system 100. For example, the light engine may be mounted to temple arm 207 of support structure 205. Moreover, in some examples, the light source of the light engine may be received in a space 210 in temple arm 207 of support structure 205.

The spatial modulator of the light engine may be received in or be part of component 215 of support structure 205. The spatial modulator, in turn, may direct the display light onto a display optic 220 mounted to a lens 225 of support structure 205. In some examples, display optic 220 may be similar in structure or function to display optic 125. Furthermore, in some examples, a power source to power the light engine may be mounted to temple arm 208 of support structure 205. In some examples, the power source may comprise a battery, and the like.

As shown in FIG. 2, when WHUD 200 is worn by the user, temple arm 207 may be worn proximate a right side of the head of the user, and temple arm 208 may be worn proximate a left side of the head of the user. While FIG. 2 shows the light engine as being mounted to temple arm 207 and the power source is described as being mounted to temple arm 208, it is contemplated that in some examples the light engine may be mounted to temple arm 208, and the power source may be mounted to temple arm 207. In examples where the light engine is mounted to temple arm 208, the display optic may also be mounted to a lens 230 mounted to front frame 206.

It is also contemplated that in some examples the light engine and the power source may be carried in the same temple arm of the glasses frame of the WHUD. Moreover, it is also contemplated that in some examples light engines may be present in both temple arms, or that power sources may be present in both temple arms.

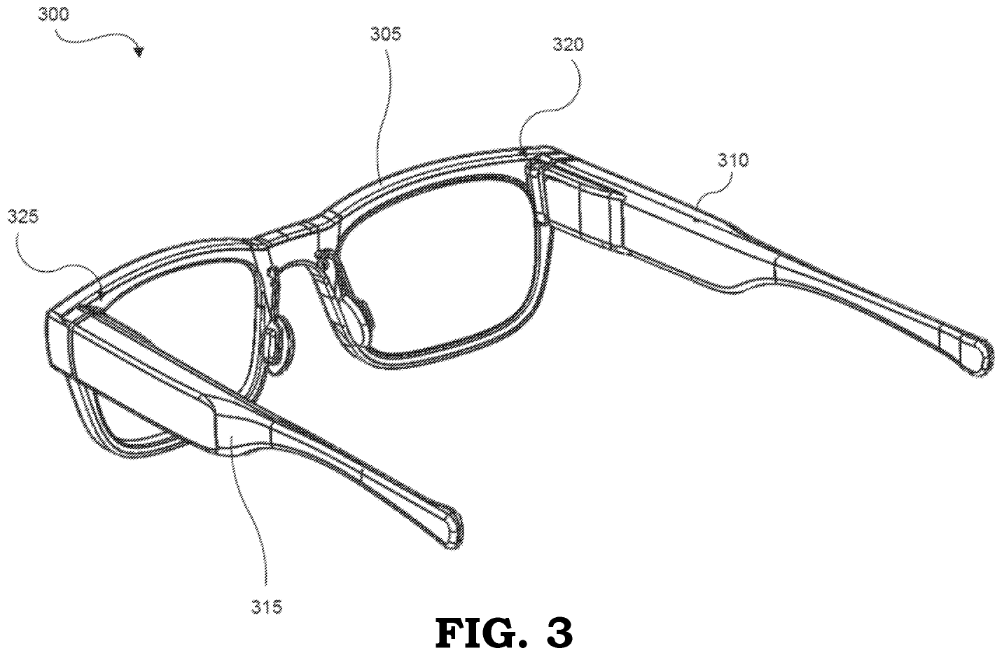

Turning now to FIG. 3, a partial top perspective view is shown of another example WHUD 300. WHUD 300 may be similar to WHUD 200. WHUD 300 may comprise a front frame 305, and temple arms 310 and 315 each coupled to front frame 305. Temple arm 310 may be foldable relative to front frame 305 at interface 320. In some examples, temple arm 310 may be hinged to front frame 305 at interface 320. Similarly, temple arm 315 may be foldable relative to front frame 305 at an interface 325. In some examples, temple arm 315 may be hinged to front frame 305 at interface 325. Moreover, while in FIG. 3 WHUD 300 is shown without a component similar to component 215 of WHUD 200, it is contemplated that WHUD 300 may comprise a component similar in structure, function, or placement to component 215 of WHUD 200.

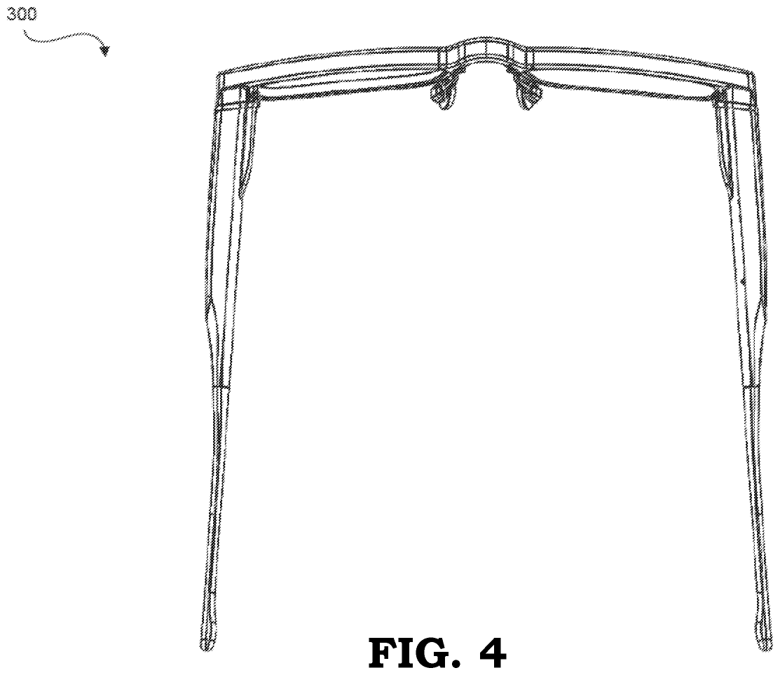

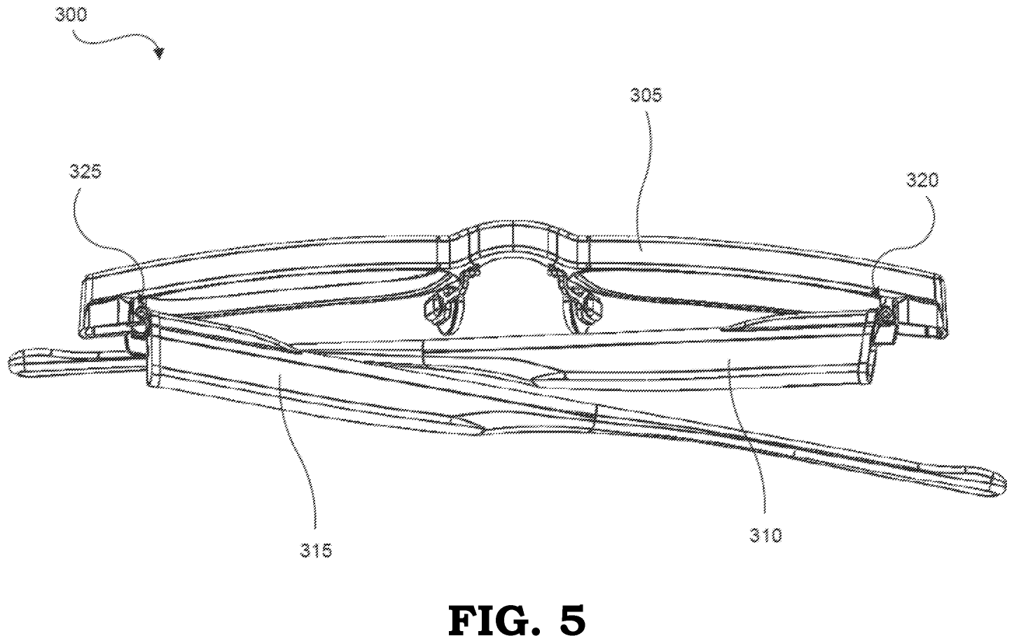

FIG. 4 shows a top plan view of WHUD 300. In both FIGS. 3 and 4, WHUD 300 is shown in its extended or unfolded configuration. FIG. 5, in turn, shows WHUD 300 in a folded configuration. As shown in FIG. 5, temple arm 310 is folded at interface 320 against front frame 305. Temple arm 315, in turn, is folded at interface 325 against the folded temple arm 310.

Referring back to FIG. 2, the display light generated by the light engine traverses an optical path extending from the light engine mounted to temple arm 207 to the display optic mounted to lens 225 carried, in turn, by front frame 206. In some examples, a first portion of this optical path may be at least partially inside temple arm 207, and may extend between the light source housed in space 210 and the spatial modulator that is housed in or implemented as component 215. A second portion of the optical path may be outside of temple arm 207, and may extend from component 215 to display optic 220.

Interface 211 may be disposed in this optical path. More specifically, interface 211 may be disposed in the second portion of this optical path extending from component 215 to display optic 220. Describing interface 211 as being in the second portion of the optical path indicates that interface 211 is positioned such that folding temple arm 207 about interface 211 may alter or interfere with the second portion of the optical path. Moreover, in some examples, altering or interfering with the second portion of the optical path may comprise changing where or whether the display light propagating from component 215 becomes incident on display optic 220.

Interface 211 being disposed in the optical path between component 215 and display optic 220 may pose challenges in achieving or maintaining proper optical alignment between component 215 and display optic 220. In other words, as component 215 of temple arm 207 is foldable (i.e., movable) relative to display optic 220 secured to front frame 206, movements or positioning of temple arm 207 relative to front frame 206 may cause changes in the optical alignment, and potential consequent misalignments, between component 215 and display optic 220. Such misalignments may cause artifacts or aberrations in the image displayed by WHUD 200, which artifacts or aberrations may degrade the quality of the images formed by WHUD 200.

In addition, having an interface in the optical path of the display light may allow for changes in the position of the temple arm relative to the front frame to alter the optical path of the display light emanating from the light engine such that the display light may be directed to a point other than towards display optic 220 or lens 225. As the display light may comprise laser light, such errant or misdirected laser light may pose a laser exposure safety risk to a user of the WHUD or to bystanders.

In order to reduce the alignment and safety challenges associated with having an interface in the optical path between the light engine and display optic, the interface may be moved to a different position along the temple arm to move the interface out of the optical path of the display light extending from the light engine mounted to the temple arm to the display optic mounted to the front frame. FIGS. 6-9 show such example WHUDs where the corresponding interfaces are moved out of the optical path of the display light to at least partially address the abovementioned alignment and safety challenges.

Turning now to FIG. 6, a partial-cutaway perspective view of an example WHUD 600 is shown. WHUD 600 may be similar to WHUD 200. A difference between WHUD 600 and WHUD 200 is that WHUD 600 comprises a temple arm 602 coupled to front frame 206, in place of temple arm 207. Temple arm 602, in turn, may be similar to temple arm 207. A difference between temple arms 602 and 207 is that a portion of temple arm 602 is foldable relative to front frame 206 at an interface 605 disposed at a distance 610 along temple arm 602 away from front frame 206.

Functionally, interface 605 divides temple arm 602 into a first portion 615 disposed on a first side of interface 605 disposed between interface 605 and front frame 206 and a second portion 620 disposed on a second side of interface 605. Second portion 620 is foldable relative to front frame 206 at interface 605, whereas first portion 615 is immovably coupled to front frame 206. In some examples, first portion 615 may be secured to front frame 206 using securing means such as a fastener, an adhesive, a snap fitting, and the like. Moreover, in some examples, first portion 615 may be integrally formed with front frame 206.

In WHUD 600 the light engine is mounted to first portion 615 of temple arm 602. Housing the light engine in first portion 615 and moving interface 605 a distance 610 away from front frame 206 may allow for moving interface 605 out of the optical path of the display light from component 215 of the light engine to display optic 220 mounted to front frame 206.

As shown in FIG. 6, interface 605 is a distance 610 away from front frame 206. Interface 212, in turn, is positioned at or substantially at an end of temple arm 208 proximate front frame 206. In other words, interface 212 is disposed at a corresponding distance along temple arm 208 away from front frame 206, which corresponding distance is zero or substantially zero. It is contemplated that in some examples distance 610, and the corresponding distance of interface 212 along temple arm 208, may be different than those shown in FIG. 6. For example, it is contemplated that the distance of interface 212 from front frame 206 along temple arm 208 may be greater than zero.

In some examples, distance 610 may be greater than the corresponding distance of interface 212 along temple arm 208 from front frame 206. Moreover, in some examples, setting distance 610 to be greater than the corresponding distance of interface 212 along temple arm 208 may allow for temple arm 602 to be divided into first and second portions. The first of these portions may be large enough to house or otherwise carry the light engine, which in turn may allow interface 605 to be positioned outside of the optical path of the display light between component 215 and display optic 220.

In examples where temple arm 208 houses the battery of WHUD 600, the considerations relating to moving the corresponding interface out of the optical path need not apply to temple arm 208. In such examples the interface associated with temple arm 208 may be positioned at a distance of zero or substantially zero along temple arm 208 from front frame 206.

When WHUD 600 is worn by a user, temple arm 602 and the light engine mounted to temple arm 602, may be worn proximate a right side of the face of the user. While being worn proximate the right side of the face of the user, the position of temple arm 602 may also be described as being proximate the right side of the head of the user. Moreover, when WHUD 600 is worn by the user, temple arm 208 and the battery mounted to temple arm 208, may be worn proximate the left side of the face of the user. This position of temple arm 208 may also be described as being proximate the left side of the head of the user.

In addition, while in WHUD 600 the light engine is mounted to temple arm 602 and the battery is mounted to temple arm 208, it is contemplated that in some examples the light engine may be mounted to temple arm 208 and the battery may be mounted to temple arm 602. Moreover, it is contemplated that in some examples both of the temple arms may carry corresponding light engines, or that both of the temple arms may carry corresponding batteries. In examples where a light engine is mounted to temple arm 208, interface 212 may also be moved along temple arm 208 further from front frame 206 to move interface 212 out of the optical path between the light engine mounted to temple arm 208 and the display optics mounted to front frame 206.

Moreover, in some examples one or more of temple arm 602 and temple arm 208 may be hinged at interfaces 605 and 212 respectively. In such examples, interfaces 605 and 212 may also be described as hinge positions. It is also contemplated that in some examples one or more of portion 620 and temple arm 208 may be foldable relative to front frame 206 using a suitable folding mechanism other than a hinge.

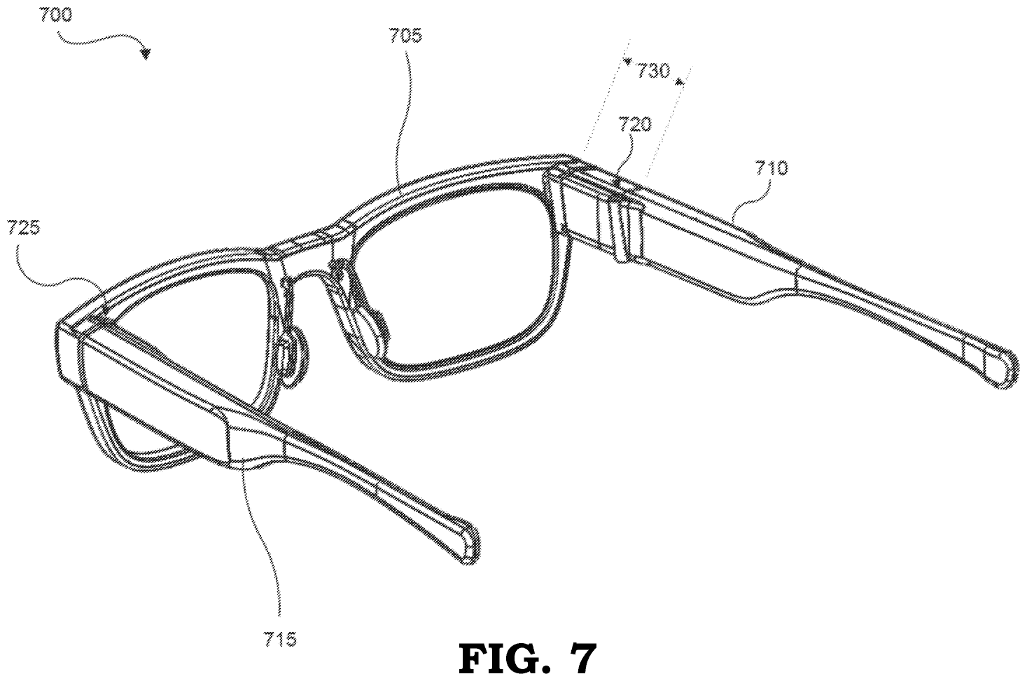

In order to increase the compactness of the folded configuration of the glasses frame of WHUD 600, distance 610 may be reduced by moving interface 605 along temple arm 602 closer to front frame 206. In order to facilitate such a move, the light engine housed in first portion 615 may be reduced in size to allow the light engine to be housed in the relatively smaller first portion that would result when interface 605 is moved closer to front frame 206. FIG. 7 shows a WHUD 700 that is similar to WHUD 600, with a difference being that in WHUD 700 the interface in the temple arm bearing the light engine is moved closer to the front frame.

Turning now to FIG. 7, a partial top perspective view is shown of another example WHUD 700. WHUD 700 may be similar to WHUD 600. WHUD 700 may comprise a front frame 705, and temple arms 710 and 715 each coupled to front frame 705. At least a portion of temple arm 710 may be foldable relative to front frame 705 at interface 720. Interface 720 may be disposed at a distance 730 along temple arm 710 away from front frame 705. In some examples, temple arm 710 may be hinged to front frame 705 at interface 720.

In some examples, distance 730 may be equal to or less than about 5 cm. Moreover, in some examples, distance 730 may be equal to or less than about 4 cm. Furthermore, in some examples, distance 730 may be equal to or less than about 3 cm. In addition, in some examples, distance 730 may be equal to or less than about 2 cm. In some examples, distance 730 may be equal to or less than about 1 cm. It is also contemplated that in some examples, distance 730 may be greater than about 5 cm.

Temple arm 715, in turn, may be foldable relative to front frame 705 at an interface 725. Interface 725 may also be disposed along temple arm 715 at a corresponding distance away from front frame 705. Distance 730 may be larger than the corresponding distance of interface 725 from front frame 705. In some examples, the corresponding distance of interface 725 from front frame 705 may be zero or about zero. It is also contemplated that in some examples the corresponding distance of interface 725 from front frame 705 may be greater than zero.

Moreover, in some examples, temple arm 715 may be hinged to front frame 705 at interface 725. Furthermore, while in FIG. 7 WHUD 700 is shown without a component similar to component 215 of WHUD 200, it is contemplated that WHUD 700 may comprise a component similar in structure, function, or placement to component 215 of WHUD 200. This component may be disposed in a first portion of temple arm 710, which first portion is disposed between interface 720 and front frame 705.

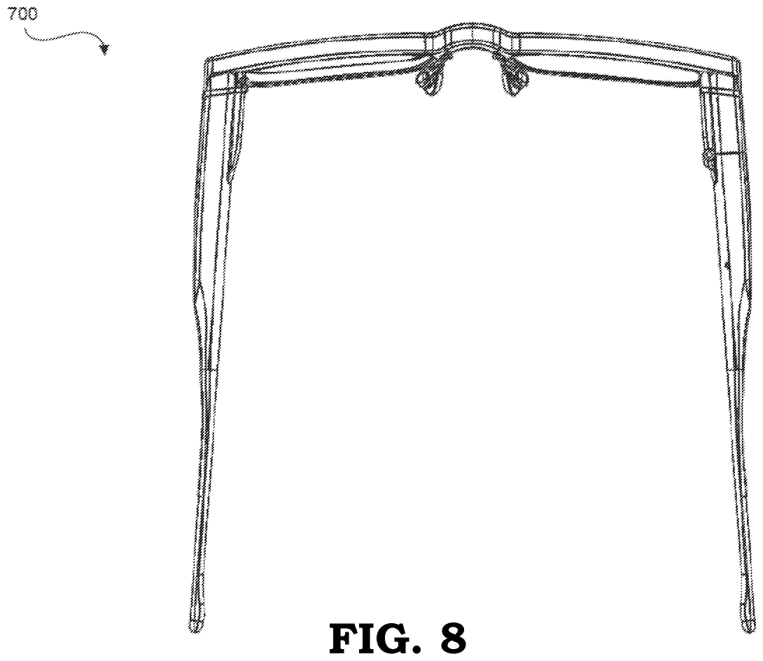

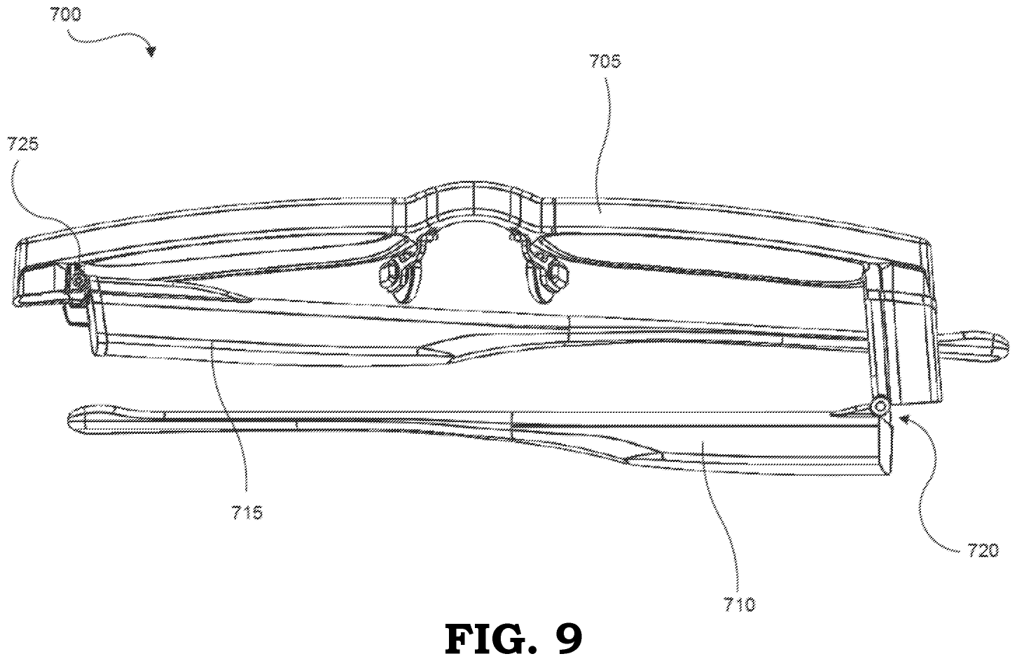

FIG. 8 shows a top plan view of WHUD 700 shown in FIG. 7. In both FIGS. 7 and 8 WHUD 700 is shown in its extended or unfolded configuration. FIG. 9, in turn, shows WHUD 700 in a folded configuration. As shown in FIG. 9, temple arm 715 is folded at interface 725 against front frame 705. Temple arm 715 folded in this manner may be described as folded temple arm 715. In some examples, to achieve this folded configuration, temple arm 715 may fold until temple arm 715 abuts against front frame 705. Moreover, in some examples, temple arm 715 may fold until it reaches the end of its folding range of motion. This end of the folding range of motion may be dictated by the geometry of the glasses frame of WHUD 700, or by the characteristics of the folding mechanism at interface 725. In some examples, this folding mechanism may comprise a hinge, and the like.

Temple arm 710, in turn, is folded at interface 725 against the folded temple arm 710. In some examples, to achieve this folded configuration, temple arm 710 may fold until it abuts against one or more of the folded temple arm 715 or front frame 705. Moreover, in some examples, temple arm 710 may fold until it reaches the end of its folding range of motion. This end of the folding range of motion may be dictated by the geometry of the glasses frame of WHUD 700, or by the characteristics of the folding mechanism at interface 720. In some examples, this folding mechanism may comprise a hinge, and the like.

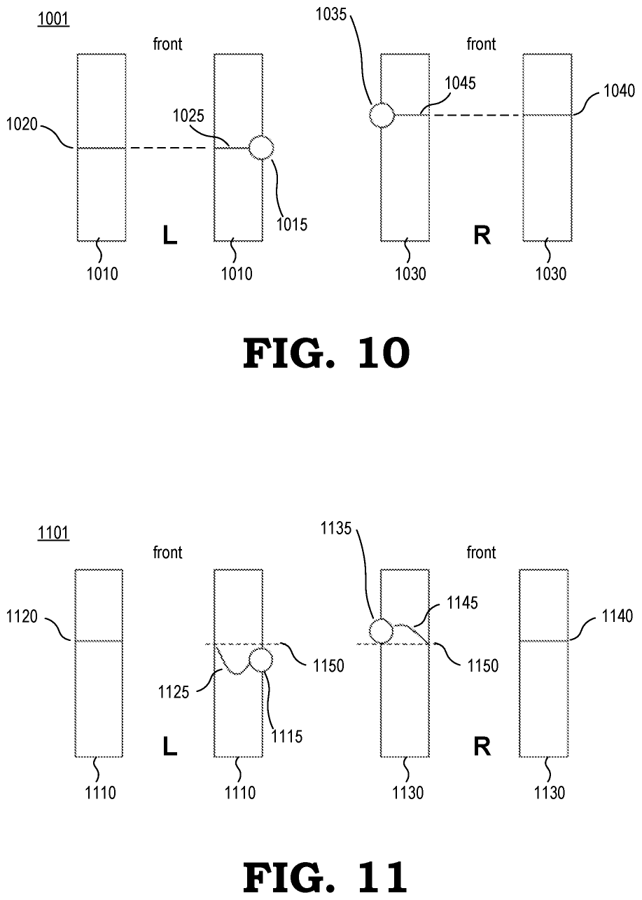

FIG. 10 shows simplified top and side plan views of an example configuration of unfolded temple arms for a WHUD, in accordance with one or more non-limiting embodiments. In particular, FIG. 10 includes an example unfolded configuration 1001 that depicts a left temple arm 1010 and a right temple arm 1030.

The simplified top plan view of the left temple arm 1010 includes a folding mechanism 1015 (e.g., a hinge) and a rectilinear interface 1025 between two portions of the left temple arm that, when folding mechanism 1015 is engaged, rotate apart. The simplified side plan view of the left temple arm 1010 illustrates the perceived interface 1020 of the two portions of the left temple arm. Similarly, the simplified top plan view of the right temple arm 1030 includes a folding mechanism 1035 (e.g., a hinge) and a rectilinear interface 1045 between two portions of the right temple arm that, when folding mechanism 1035 is engaged, rotate apart. The simplified side plan view of the right temple arm 1030 illustrates the perceived interface 1040 of the two portions of the right temple arm.

Notably, the asymmetrical configuration of folding mechanisms 1015 and 1035 are visually apparent from an external side view of the unfolded configuration 1001—that is, an external observer viewing the unfolded configuration first from the left side and then the right, or vice versa, would easily detect that the respective temple arms 1010 and 1030 are to be folded at different distances from the front frame, as the perceived interface 1020 of the left temple arm 1010 is located at a different distance from that front frame than the perceived interface 1040 of the right temple arm 1030. In certain scenarios, this asymmetrical nature of the perceived interfaces may distract or otherwise negatively affect the external observer's perception of the WHUD.

FIG. 11 shows simplified top and side plan views of an alternative example configuration of unfolded temple arms for a WHUD, in accordance with one or more non-limiting embodiments. The example unfolded configuration 1101 depicts a left temple arm 1110 and a right temple arm 1130.

The simplified top plan view of the left temple arm 1110 includes a folding mechanism 1115 (e.g., a hinge) and a curvilinear interface 1125 between two foldable portions of the left temple arm that, when folding mechanism 1115 is engaged, rotate apart. The simplified side plan view of the left temple arm 1110 illustrates the perceived interface 1120 of the two foldable portions of the left temple arm. Similarly, the simplified top plan view of the right temple arm 1130 includes a folding mechanism 1135 (e.g., a hinge) and a curvilinear interface 1145 between two foldable portions of the right temple arm that, when folding mechanism 1135 is engaged, rotate apart. The simplified side plan view of the right temple arm 1130 illustrates the perceived interface 1140 of the two foldable portions of the right temple arm.

In contrast with the example embodiment of FIG. 10, in the depicted embodiment of FIG. 11 the asymmetrical configuration of folding mechanisms 1115 and 1135 is generally less easily observable from an external side view of the unfolded configuration 1101—that is, an external observer viewing the unfolded configuration first from the left side and then the right, or vice versa, would generally be unable to detect that the respective temple arms 1110 and 1130 are to be folded at different distances from the front frame, as the perceived interface 1120 of the left temple arm 1110 is located at the same distance from that front frame as the perceived interface 1140 of the right temple arm 1130. In particular, both perceived interfaces 1120 and 1140 lay along the same axis 1150. In certain scenarios, this configuration may mitigate or diminish any distraction or otherwise negative perception of the WHUD associated with the asymmetrical configuration depicted in FIG. 10.

It will be appreciated that in various embodiments and configurations, additional types of interfaces may be used between the foldable portions of left temple arm 1110 and right temple arm 1130. For example, a variety of curvilinear interfaces may be used other than those depicted in FIG. 11. As another example, rectilinear interfaces may be used that nonetheless mask the asymmetrical distances between the front frame of the WHUD and folding mechanisms 1115 at 1135, respectively—such as by forming a first rectilinear interface between the folding mechanism 1115 and the perceived interface 1120 (with respect to the left temple arm) and forming a second rectilinear interface between the folding mechanism 1135 and the perceived interface 1140 (with respect to the right temple arm). In this manner, rectilinear interfaces between the folding portions of the respective temple arms may be used while perceived interfaces 1120 and 1140 are still located along axis 1150. Moreover, such interfaces (curvilinear and/or rectilinear) may be used in various embodiments consistent with and/or comprising features described elsewhere herein with respect to FIGS. 1-9.

Throughout this specification and the appended claims, infinitive verb forms are often used. Examples include, without limitation: “to receive,” “to generate,” “to form,” and the like. Unless the specific context requires otherwise, such infinitive verb forms are used in an open, inclusive sense, that is as “to, at least, receive,” “to, at least, generate,” “to, at least, form,” and so on.

The above description of illustrated example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A wearable heads-up display (WHUD) comprising:
a glasses frame comprising a front frame and a first temple arm and a second temple arm that are each coupled to the front frame, wherein:
at least a portion of the first temple arm is foldable relative to the front frame at a first interface disposed at a first distance from the front frame along an inner side of the first temple arm; and
at least a portion of the second temple arm is foldable relative to the front frame at a second interface disposed at a second distance from the front frame along an inner side of the second temple arm, the first distance different than the second distance and the inner side of the first temple arm facing the inner side of the second temple arm;
a light engine mounted to the glasses frame, the light engine to generate a display light; and
a display optic mounted to the glasses frame, the display optic to receive the display light from the light engine and direct the display light towards an eye of a user of the WHUD to form an image viewable by the user.

2. The WHUD of claim 1, wherein the first distance is longer than the second distance.

3. The WHUD of claim 1, wherein the light engine is mounted to the first temple arm.

4. The WHUD of claim 3, wherein:
the first temple arm comprises a first portion disposed between the first interface and the front frame and a second portion disposed between the first interface and a distal end of the first temple arm that is remote from the front frame; and
the light engine is mounted to the first portion of the first temple arm.

5. The WHUD of claim 3, wherein the first interface is positioned outside of an optical path of the display light from the light engine to the display optic.

6. The WHUD of claim 4, wherein the first portion is immovably coupled to the front frame.

7. The WHUD of claim 1, wherein:
the first interface extends from a first interface position located at the first distance from the front frame along the inner side of the first temple arm to a first perceived interface position at a third distance from the front frame along an outer side of the first temple arm;
the second interface extends from a second interface position located at the second distance from the front frame along the inner side of the second temple arm to a second perceived interface position at the third distance from the front frame along an outer side of the second temple arm; and
the outer side of the first temple arm is opposite the inner side of the first temple arm and the outer side of the second temple arm is opposite the inner side of the second temple arm.

8. The WHUD of claim 7, wherein the third distance is different from the first distance and from the second distance.

9. The WHUD of claim 7, wherein at least one interface of the first interface and second interface is curvilinear.

10. The WHUD of claim 2, wherein the second distance is about zero.

11. The WHUD of claim 1, wherein:
one or more of the first temple arm and the second temple arm are hinged at the first interface and the second interface respectively; and
one or more of the corresponding first interface and second interface comprise respectively a first hinge position along the first temple arm and a second hinge position along the second temple arm.

12. The WHUD of claim 1, wherein the light engine comprises a light source to emit the display light.

13. The WHUD of claim 12, wherein the light source comprises a laser to emit the display light.

14. The WHUD of claim 12, wherein the light engine further comprises a spatial modulator to receive the display light from the light source and direct the display light onto the display optic.

15. The WHUD of claim 14, wherein the spatial modulator comprises a movable reflector.

16. The WHUD of claim 1, wherein the display optic comprises a diffractive optical element.

17. The WHUD of claim 1, wherein:
the WHUD further comprises a lens mounted to the front frame; and
the display optic is mounted to the lens.

18. The WHUD of claim 1, further comprising a battery to power the light engine.

19. The WHUD of claim 18, wherein:
the first distance is longer than the second distance; and
the battery is mounted to the second temple arm.

20. The WHUD of claim 1, further comprising a controller in communication with the light engine, the controller to control the light engine.

21. The WHUD of claim 20, wherein the light engine comprises a light source and a spatial modulator, and the controller is to control one or more of the light source and the spatial modulator.

22. The WHUD of claim 1, wherein:
the first distance is longer than the second distance; and
the glasses frame has a folded configuration wherein:
the portion of the second temple arm folds against the front frame to form a folded second temple arm; and
the corresponding portion of the first temple arm folds against the folded second temple arm.
